(19) United States
(12) Patent Application Publication
(10) Pub. No.: US 2012/0150929 A1
(43) Pub. Date: Jun. 14, 2012

(54) APPARATUS AND METHOD FOR MANAGING A PLURALITY OF ALBUMS

(75) Inventors: Genying Xie, Nanjing (CN); Shu Tan, Nanjing (CN); Ming Kong, Nanjing (CN); Ying Ge, Nanjing (CN); Lin Xie, Nanjing (CN); Jin Wang, Nanjing (CN)

(73) Assignee: SAMSUNG ELECTRONICS CO., LTD., Suwon-si (KR)

(21) Appl. No.: 13/314,931

(22) Filed: Dec. 8, 2011

(30) Foreign Application Priority Data
Dec. 8, 2010 (CN) 201010591389.3

(51) Int. Cl. G06F 17/30

(52) U.S. Cl. 707/825; 707/E17.01

(57) ABSTRACT

A management apparatus and a management method manage a plurality of albums. The management apparatus may include: a storing module which stores related information of photographs included in the plurality of albums; and an updating module which update the related information of photographs stored in the storing module according to copy, move or deletion of a photograph. The management apparatus may further include: an extracting module which in response to the user's request for displaying, copying, moving or sharing a photograph or an album, accesses an album which stores the photograph or the album requested by the user, so as to extract the photograph or album requested by the user.

### CROSS-REFERENCE TO RELATED APPLICATION(S) AND CLAIM OF PRIORITY

The present application is related to and claims the benefit under 35 U.S.C. §119(a) of Chinese Patent Application filed on Dec. 8, 2010 and assigned Serial No. 201010591389.3, the entire disclosure of which is hereby incorporated by reference.

### TECHNICAL FIELD OF THE INVENTION

The present invention relates to management of a plurality of albums for storing digital photograph, more particularly, the present invention relates to an apparatus and a method for managing a plurality of albums.

### BACKGROUND OF THE INVENTION

Existing photograph management can be divided to a local management and an online management. The local management is limited to the size of the storage space in a hard-disc, and there is a risk of losing data due to damage of the hard-disc. An online managing website, such as flicker and Picasa, can upload photographs without limit. Thus, currently a plurality of users use a web album to store and manage photographs. In addition, since some photographs are private, a user may not desire to upload these photographs to the website because of security concerns and usually stores and manages such photographs locally.

Currently used web albums include flicker, Picasa, Wangyi hard-disc, social networking service (SNS) websites and the like. There are two purposes for which the user uploads photographs to the web albums, one purpose is to backup photographs, and the other purpose is to share photographs. However, since websites used among friends are different, in order to share photographs of the user with friends, the user usually needs to upload photographs to different web albums for sharing. Therefore, the user usually has a plurality of web albums.

Currently, most of SNS websites and instant charting tools support photograph sharing functions. Therefore, sharing photographs between different websites facilitates the requirements of users.

When a user has stored photographs in a plurality of web albums, and has photographs stored locally, the user cannot manage photographs uniformly, which causes trouble for the user to view and manage photographs.

Currently, although an embedded device, such as a mobile telephone, supports viewing local albums and web albums, the user cannot manage and view the photographs uniformly, which only slightly improves the user experience. In addition, the current photograph sharing is limited to web photograph sharing.

Therefore, an apparatus and a method for managing a plurality of albums are needed.

### SUMMARY OF THE INVENTION

To address the above-discussed deficiencies of the prior art, it is a primary object to provide a apparatus and a management for viewing and managing a local album and a web album, the apparatus and the method make a user to manage the local album and the web album uniformly, so as to reduce a complicated operation of viewing and managing a plurality of albums, and to provide a mode for sharing local photographs safely.

According to an aspect of the present disclosure, a apparatus for managing a plurality of albums is provided, and the apparatus may include: a storing module which stores related information of photographs included in the plurality of albums; an updating module which update the related information of photographs stored in the storing module according to copy, move or deletion of a photograph.

The apparatus may further include: an extracting module which in response to the user's request for displaying, copying, moving or sharing a photograph or an album, accesses an album which stores the photograph or the album requested by the user, so as to extract the photograph or album requested by the user.

According to another aspect of the present disclosure, a apparatus for managing a plurality of albums is provided, and the apparatus includes: an extracting module which, in response to a user's request for sharing a photograph or an album, accesses an album having stored the photograph or the album requested by the user, so as to extract the photograph or the album requested by the user; a sharing module which stores the photograph or the album extracted by the extracting module, creates a link for the stored photograph or album, when there is a website requesting for accessing a photograph or a album shared by the user, the sharing module shares the created link to the website; after the photograph or the album is viewed, or a time for sharing exceeds a predetermined period, the sharing module breaks the link.

The apparatus may further include: a displaying module which displays photographs or albums in response to the user's request for displaying photographs or albums, wherein when the user requests to display a photograph or an album, the extracting module may send the extracted photograph or album to the displaying module, and the displaying module may display the extracted photograph or album.

When the user requests to display photographs in at least one album in the plurality of albums in category, the extracting module may extract the photographs in the album requested by the user, and classify the extracted photographs based on the related information of photographs stored in the storing module, and the displaying module displays the photographs classified by the extracting module in category.

When the user requests to display a photograph, if the extracting module determines that at least two albums in the plurality of albums have the photograph according to the related information of photographs, stored in the storing module, the extracting module may only extract the photograph from the album which has the fastest speed of reading among said at least two albums, and send the extracted photograph to the displaying module to be displayed.

When the user requests to display a same photograph, the extracting module extracts the same photograph in the plurality of albums according to the related information of photographs, stored in the storing module, the displaying module may display the extracted same photograph, and display information on which albums store the same photograph, so that the user may delete or maintain the same photograph.

When the user requests to copy a photograph from an album A in the plurality of albums to another album B in the plurality of albums, the extracting module may extract the photograph from the album A, the storing module stores the photograph extracted by the extracting module in the album B, and the updating module updates the related information of the photograph.

When the user requests to copy a photograph from an album A in the plurality of albums to another album B in the plurality of albums, and a photograph cannot be directly copied between the album A and the album B, the extracting module may extract the photograph from the album A, the storing module stores the photograph extracted by the extracting module to the local memory temporarily, and then stores this photograph to the album B from the local memory, and the updating module updates the related information of the photograph.

When the user requests to move a photograph from the album A in the plurality of albums to another album B in the plurality of albums, the extracting module may extract the photograph from the album A and delete the photograph from the album A, the storing module stores the photograph extracted by the extracting module in the album B, and the updating module updates the related information of the photograph.

When the user requests to move a photograph from an album A in the plurality of albums to another album B in the plurality of albums, and a photograph cannot be directly moved between the album A and the album B, the extracting module may extract the photograph from the album A and delete the photograph from the album A, the storing module stores the photograph extracted by the extracting module to the local memory temporarily, and then stores this photograph to the album B from the local memory, and the updating module updates the related information of the photograph.

The related information of photographs may includes at least one of the color of a photograph, the name of a photograph, the web attribute of a photograph, the position of taking a photograph, the time of taking a photograph, the storing position of a photograph, the storing time of a photograph, and the main object of a photograph.

At least one of the plurality of albums may be a web album.

The apparatus further may include a management module for setting and verifying a user name and a password.

According to another aspect of the present disclosure, a method for managing a plurality of albums is provided, and the method includes: storing related information of photographs included in the plurality of albums; updating the related information of photographs stored in the storing module according to copy, move or deletion of a photograph.

According to another aspect of the present disclosure, a method for managing a plurality of albums is provided, and the method includes: in response to the user's request for sharing a photograph or an album, accessing an album having stored the photograph or the album requested by the user, so as to extract the photograph or album requested by the user to be shared; storing the extracted photograph or album, and creating a link for the stored photograph or album, when there is a website requesting for accessing a photograph or a album shared by the user, the created link is shared to the website; after the photograph or the album is viewed, or a time for sharing exceeds a predetermined period, the link is broken.

The method may further include: in response to the user's request for displaying, copying, moving or sharing a photograph or an album, accessing an album which stores the photograph or the album requested by the user, so as to extract the photograph or album requested by the user.

The method may further include: displaying the extracted photographs or albums in response to the user's request for displaying photographs or albums.

When the user requests to display photographs in at least one album in the plurality of albums in category, the photographs in the album requested by the user may be extracted, and the extracted photographs are displayed in category based on the stored related information of photographs.

When the user requests to display a photograph, if it is determined that at least two albums in the plurality of albums have the photograph according to the stored related information of photographs, the photograph may only be extracted from the album which has the fastest speed of reading among said at least two albums, and the extracted photograph is displayed.

When the user requests to display a same photograph, the same photograph in the plurality of albums may be extracted according to the stored related information of photographs, the extracted same photograph is displayed, and information on which albums store the same photograph is displayed, so that the user deletes or maintains the same photograph.

When the user requests to copy a photograph from an album A in the plurality of albums to another album B in the plurality of albums, the photograph may be extracted from the album A, the extracted photograph is stored in the album B, and the related information of the photograph is updated.

When the user requests to copy a photograph from an album A in the plurality of albums to another album B in the plurality of albums, and a photograph cannot be directly copied between the album A and the album B, the photograph may be extracted from the album A, the extracted photograph is stored to the local memory temporarily, and then this photograph is stored to the album B from the local memory, and the related information of the photograph is updated.

When the user requests to move a photograph from the album A in the plurality of albums to another album B in the plurality of albums, the photograph may be extracted and deleted from the album A, the extracted photograph is stored in the album B, and the related information of the photograph is updated.

When the user requests to move a photograph from an album A in the plurality of albums to another album B in the plurality of albums, and a photograph cannot be directly moved between the album A and the album B, the photograph may be extracted and deleted from the album A, the extracted photograph is stored to the local memory temporarily, and then this photograph is stored to the album B from the local memory, and the related information of the photograph is updated.

The method may further include: in response to the user's request for sharing a photograph or an album, accessing an album having stored the photograph or the album requested by the user, so as to extract the photograph or album requested by the user to be shared; storing the extracted photograph or album, and creating a link for the stored photograph or album, when there is a website requesting for accessing a photograph or a album shared by the user, the created link is shared to the website; after the photograph or the album is viewed, or a time for sharing exceeds a predetermined period, the link is broken.

The related information of photographs may include at least one of the color of a photograph, the name of a photograph, the web attribute of a photograph, the position of taking a photograph, the time of taking a photograph, the storing position of a photograph, the storing time of a photograph, and the main object of a photograph.

At least one of the plurality of albums may be a web album.

The method may further include: setting and verifying a user name and a password.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a management apparatus for managing a plurality of albums according to an exemplary embodiment of the present disclosure;

FIG. 2 illustrates moving a photograph according to an exemplary embodiment of the present disclosure;

FIGS. 3A-C illustrate photographs displayed by category; and

FIG. 4 illustrates a method for managing a plurality of albums according to another exemplary embodiment of the present disclosure.

### DETAILED DESCRIPTION OF THE INVENTION

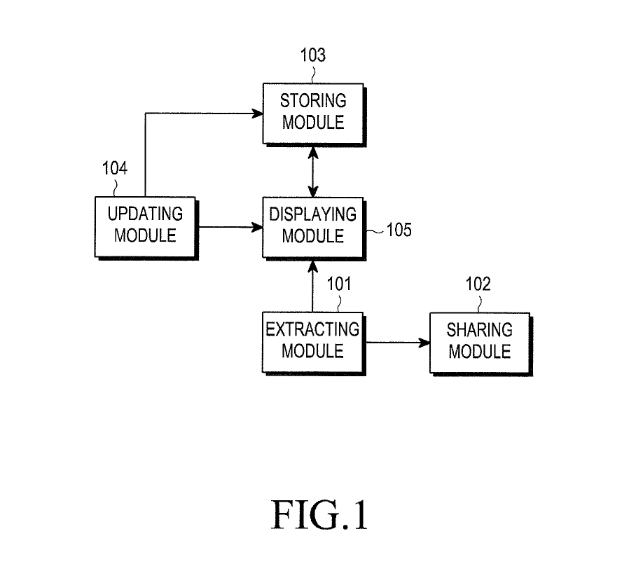

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged album management system. Hereinafter, exemplary embodiments of the present invention will be described with reference to the accompanying drawings. In the following description, the same reference number refers to the same element although illustrated in different drawings. Since detailed description for the known functions and structures blurs the subject of the present invention, and the functions and structures are known for those common skilled in the art, the detailed description will be omitted for the purpose of being clear and concise.

According to an exemplary embodiment of the present disclosure, a management apparatus may receive a user input for management request that each digital image (such as a photograph) be included in a plurality of albums from a user. The management request may be one of displaying, copying, moving, sharing and deleting the digital image.

FIG. 1 illustrates a management apparatus for managing a plurality of albums according to an exemplary embodiment of the present disclosure.

By referring to FIG. 1, the management apparatus for managing a plurality of albums according to the exemplary embodiment of the present disclosure may include an extracting module 101, a sharing module 102, a storing module 103, an updating module 104 and a displaying module 105. At least one of a plurality of albums is a web album stored in web site, that is, the plurality of albums may include web albums and local albums. The local albums may be stored on a hard disk drive.

Hereinafter, a respective module will be described in detail.

In response to a request for displaying, copying, moving or sharing photographs or albums from a user, the extracting module 101 may access albums storing the photographs or the requested album, so as to extract the photographs or album requested by the user.

The sharing module 102 may create a link for sharing photographs or albums, in response to the user's request for sharing photographs or albums.

The storing module 103 may store related information of photographs included in the plurality of albums. In the present application, the related information of photographs may include at least one of the color of a photograph, the name of a photograph, the web attribute of a photograph, a place where the photograph was taken, the time when a photograph was taken, a location where a photograph is stored, the time a photograph was stored, and the main object (or subject) of a photograph and the like. The location where the photograph is stored may include information of an album where the corresponding photograph is stored. In addition, the storing module 103 may store a photograph in different albums.

The updating module 104 may update the related information of photographs stored in the storing module 103 according to the copying, moving or deleting photograph in the plurality of albums.

The displaying module 105 displays photographs or the related information of the photographs, in response to the user's request for displaying photographs. In addition, the displaying module 105 may display photographs in category, according to the related information of photographs, stored in the storing module 103.

FIG. 1 illustrates the management apparatus for managing a plurality of albums, since the storing module 103 has stored the related information of photographs included in the plurality of albums, the photographs in the plurality of albums can be uniformly managed according to the related information. In addition, the updating module 104 may update the related information of photographs stored in the storing module 103 according to operations performed regarding the photographs (e.g., copy, move or deletion operations), so that the management apparatus managing the plurality of albums can uniformly manage the photographs in the plurality of albums according to the updated related information. However, those skilled in the art should appreciate that, with respect to different requirement of users (that is, with respect to different technical problems to be solved), the management apparatus for managing the plurality of albums may only include a portion of the elements described in FIG. 1. Hereinafter, examples according to an exemplary embodiment of the present disclosure will be described with respect to different requirement of users.

With respect to the user's request for sharing a photograph or an album, the management apparatus for managing a plurality of albums according to an exemplary embodiment of the present disclosure may include the extracting module 101 and the sharing module 102.

In response to the user's request for sharing a photograph or an albums, the extracting module 101 accesses an album storing the photograph or the album requested by the user to be shared, so as to extract the photograph or the album requested by the user to be shared.

The sharing module 102 stores the photograph or the album extracted by the extracting module 101, and creates a link for the stored photograph or the album. When there is website to access the photograph or the album shared by the user, the sharing module 102 shares the created link to the website. After the photograph or the album is viewed, or a time for sharing exceeds a predetermined period, the sharing module 102 deactivates the link.

With respect to the user's request for copying or moving a photograph among different albums, the management apparatus for managing a plurality of albums according to an exemplary embodiment of the present disclosure may include the extracting module 101 and the storing module 103. The detailed description will be given with respect to copying photographs and moving photographs among different albums in below.

When a user requests to copy a photograph from an album (album A) in the plurality of albums to another album (album B) in the plurality of albums, the extracting module 101 extracts the photograph from the album A, and the storing module 103 stores the photograph extracted by the extracting module 101 in the album B.

When the user requests to move a photograph from the album A in the plurality of albums to another album B in the plurality of albums, the extracting module 101 extracts the photograph from the album A and deletes the photograph from the album A, and the storing module 103 stores the photograph extracted by the extracting module 101 in the album B.

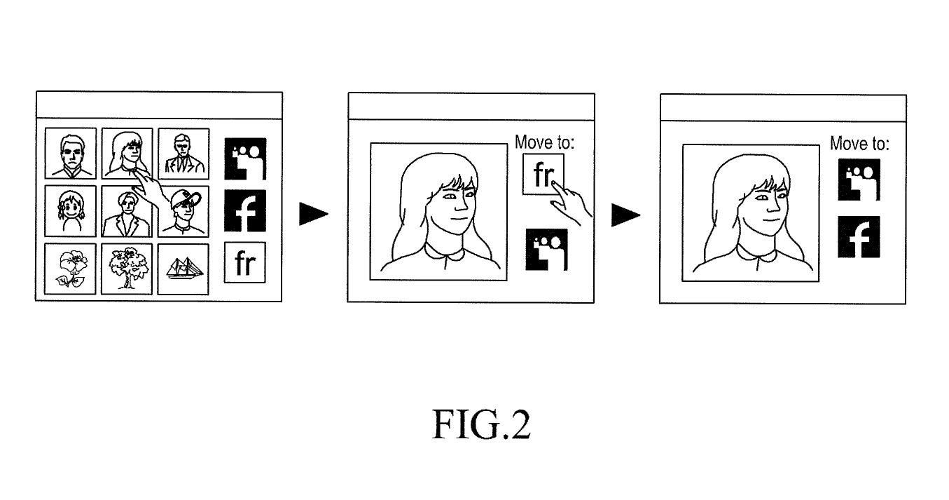

FIG. 2 is a view of moving a photograph according to an exemplary embodiment of the present disclosure.

As illustrated in FIG. 2, the user selects a photograph from the displayed photographs, and modifies the storing address of the photograph, so that the user can conveniently move the photograph from one album to another album.

According to another exemplary embodiment of the present disclosure, when both the album A and the album B are web albums, and the two web albums do not support an function of copying or moving a photograph with each other, with respect to the user's request for copying or moving a photograph among different albums (for example, copying or moving a photograph X from the web album A to the web album B), it needs to temporarily store the photograph to a local memory (for example, a local memory of the management apparatus) first, and then store the photograph to the web album B.

In particular, when the user requests to copy a photograph from an album A in the plurality of albums to another album B in the plurality of albums, the extracting module 101 extracts the photograph from the album A, and the storing module 103 stores the photograph extracted by the extracting module 101 to the local memory temporarily, and then stores this photograph to the album B from the local memory.

when the user requests to move a photograph from an album A in the plurality of albums to another album B in the plurality of albums, the extracting module 101 extracts the photograph from the album A and deletes the photograph from the album A, and the storing module 103 stores the photograph extracted by the extracting module 101 to the local memory temporarily, and then stores this photograph to the album B from the local memory.

In addition, with respect to the user's request for copying or moving a photograph among different albums, the management apparatus for managing a plurality of albums according to another exemplary embodiment of the present disclosure may further include the updating module 104.

The storing module 103 may store the related information of the photographs included in the plurality of albums. The updating module 104 may modify the related information of the photograph (for example, the storing address of the photograph) stored in the storing module 103, according to the copying, moving or deleting a photograph among different albums. For example, when copying the photograph X from the album A to the album B, the updating module 104 may update the related information of the photograph X, stored in the storing module 103, for example, add a storing address (for example, the album B) for the photograph X. For example, when moving the photograph X from the album A to the album B, the updating module 104 may update the storing address of the photograph X, stored in the storing module 103, from the album A to the album B.

With respect to the user's request for viewing (or displaying) a photograph, the management apparatus for managing a plurality of albums according to an exemplary embodiment of the present disclosure may include the extracting module 101 and the displaying module 105. When the user requests to display a photograph, the extracting module 101 accesses an album storing the photograph, so as to extract the photograph, and sends the extracted photograph to the displaying module 105, and the displaying module 105 displays the extracted photograph.

When the user requests to display a same photograph, the extracting module 101 extracts the same photograph in the plurality of albums according to the related information (for example, the storing addresses of photographs are different, but other related information of photographs are same) of photographs, stored in the storing module 103, the displaying module 105 displays the extracted same photograph, and displays which albums store the same photograph, so that the user can manage (such as delete or maintain) the same photograph in the different albums,

When the user requests to display a photograph, according to the related information of photographs, stored in the storing module 103, (for example, the storing addresses of photographs are different, but other related information of photographs are same), if the extracting module 101 determines that at least two albums in the plurality of albums have the photograph, the extracting module 101 may only extract the photograph from the album which has a faster access speed, and sends the extracted photograph to the displaying module 105 to be displayed.

With respect to the user's request for viewing photographs in category, the management apparatus for managing a plurality of albums according to another exemplary embodiment of the present disclosure may include the extracting module 101, the storing module 103, the updating module 104 and the displaying module 105.

Herein, the storing module 103 stores the related information of photographs included in the plurality of albums, the updating module 104 may update the related information of photographs stored in the storing module 103, according to the copying, moving or deleting a photograph among the plurality of albums, the displaying module 105 may display photographs in category according to the related information of photographs, updated by the updating module 104 at any moment. Wherein, the related information of photographs may include at least one of the color of a photograph, the name of a photograph, the web attribute of a photograph, the place where the photograph was taken, the time when a photograph was taken, a location where a photograph is stored, the time a photograph was stored, and the main object (or subject) of a photograph and the like.

In particular, when the user requests to display photographs in one album or the plurality of albums in category, the extracting module 101 extracts the photographs requested by the user from corresponding album, and classifies the photographs based on the related information of photographs stored in the storing module 103, and the displaying module 105 displays the photographs classified by the extracting module 101 in category.

In an exemplary embodiment of the present disclosure, the user may select a category displaying option (such as color, location, map, a storing address) for displaying photographs in category, displayed in a user interface. After the user has selected the category, the extracting module 101 classifies the photographs, according to the category selected by the user, based on the related information of photographs stored in the storing module 103. For example, a color category classifies photographs according to color information of photographs, a map category classifies photographs according to the positions of taking photographs, for example, GPS information provided in photographs, and a storing address category classifies photographs according to the web addresses and the local addresses where the photographs are stored.

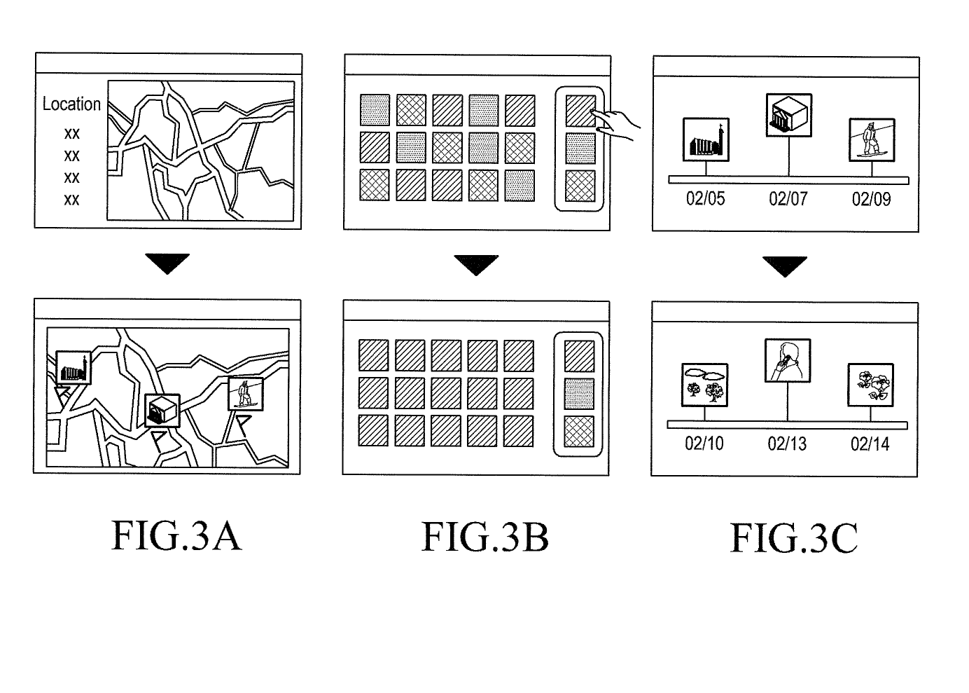

FIGS. 3A-C illustrates photographs displayed by category, wherein FIG. 3A illustrates displaying photographs in category according to map location; FIG. 3B illustrates displaying photographs in category according to color, and FIG. 3C illustrates displaying photographs in category according to a time when the photographs were taken.

By displaying photographs in category, the user can easily view or find a desired photograph.

In addition, according to another exemplary embodiment of the present disclosure, the management apparatus for managing a plurality of albums may further include a management module (not illustrated), which is used to set and verify a user name and a password, wherein the user name and the password may be a user name and a password of the management apparatus, and can also be a user name and a password of web albums.

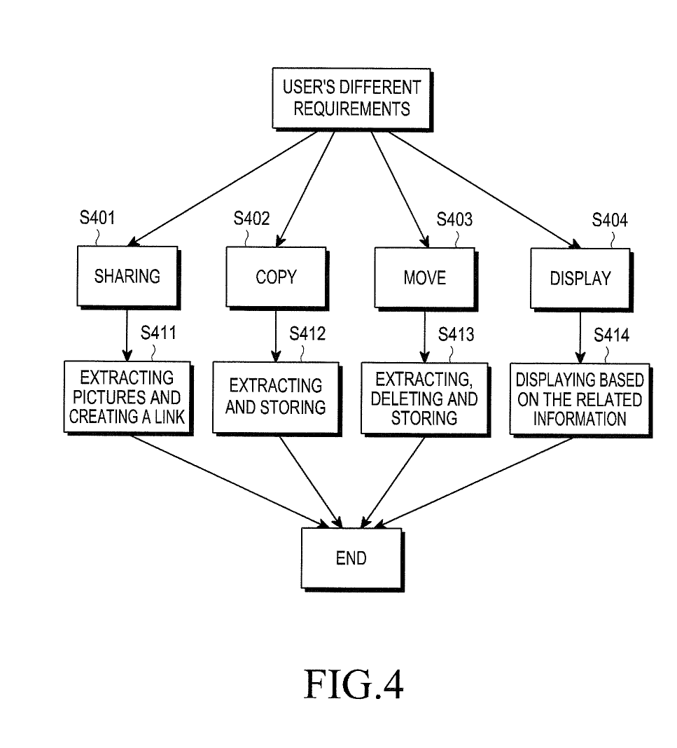

FIG. 4 illustrates a management method for managing a plurality of albums according to another exemplary embodiment of the present disclosure. Hereinafter, a detailed description will be given by referring to FIG. 4. At least one album of the plurality of albums can be a web album. In various embodiments, the management method may be performed, for example, by the management apparatus of FIG. 1.

FIG. 4 is a flowchart for illustrating the management method for managing a plurality of albums, and the management method includes different operations related to a user's different requests (such as share, copy, move and display) for photographs or albums, but those skilled in the art should be appreciate that, with respect to user's different requirements (that is, with respect to different technical problems to be solved), the management method for managing a plurality of albums may only include a part of the steps described. Hereinafter, examples according to an exemplary embodiment of the present disclosure will be described with respect to different requirement of users.

With respect to the user's request for sharing a photograph or an album (S401), the management method for managing a plurality of albums according to an exemplary embodiment of the present disclosure may include the following step (S411): in response to the user's request for sharing a photograph or an albums, an album, which stores the photograph or the album requested by the user to be shared, is accessed, so as to extract the photograph or the album requested by the user to be shared. The extracted photograph or the album is stored and a link for the stored photograph or the album is created. When there is a website requesting for accessing the photograph or the album shared by the user, the created link is shared to the website. After the photograph or the album is viewed, or a time for sharing exceeds a predetermined period, the link is deactivated. For example, the website sends request for accessing the photograph or the album shared by the user, to the management apparatus, and the management apparatus provide the created link to the website. The website accesses the photograph or the album shared by the user using the link.

When a user requests to copy a photograph from an album to another album (S402), the management method for managing a plurality of albums according to another exemplary embodiment of the present disclosure may include the following step (S412). When the user requests to copy a photograph from the album A in the plurality of albums to another album B in the plurality of albums, the photograph is extracted from the album A, and the extracted photograph is stored in the album B.

When a user requests to move a photograph from an album to another album (S403), the management method for managing a plurality of albums according to another exemplary embodiment of the present disclosure may include the following step (S413). When the user requests to move a photograph from the album A in the plurality of albums to another album B in the plurality of albums, the photograph is extracted from the album A and then deleted from the album A, and the extracted photograph is stored in the album B.

According to another exemplary embodiment of the present disclosure, when both the album A and the album B are web albums, and the two web albums do not support an function of copying or moving a photograph with each other, with respect to the user's request for copying or moving a photograph among different albums (for example, copying or moving a photograph X from the web album A to the web album B), the management apparatus needs to temporarily store the photograph to a local memory first and then store the photograph to the web album B.

For example, the step S412 may include the following steps: when the user requests to copy a photograph from an album A in the plurality of albums to another album B in the plurality of albums, the photograph is extracted from the album A, and the extracted photograph is stored to the local memory temporarily, and then this photograph is stored to the album B from the local memory.

For example, the step S413 may include the following steps: when the user requests to move a photograph from an album A in the plurality of albums to another album B in the plurality of albums, the photograph is extracted and deleted from the album A, and the extracted photograph is stored to the local memory temporarily, and then this photograph is stored to the album B from the local memory.

Herein, related information of photographs included in the plurality of albums can be stored, and the stored related information of photographs can be updated when photographs are copied, moved, or deleted.

With respect to the user's request for displaying a photograph (S404), the management method for managing a plurality of albums according to an exemplary embodiment of the present disclosure may include the following step (S412) When the user requests to display a photograph, an album for storing the photograph is accessed, so as to extract the photograph. Then the extracted photograph is displayed.

According to another exemplary embodiment of the present disclosure, the step S412 may be follows: when the user requests to display a same photograph, the same photographs existing in the plurality of albums are extracted according to the stored related information of photographs, the extracted same photographs are displayed, and information for which albums store the same photograph is displayed, so that the user can delete or maintain the same photograph.

According to another exemplary embodiment of the present disclosure, the step S412 may be follows: when the user requests to display photographs in category, the photographs are categorized based on the stored related information of the photographs, a photograph to be displayed is extracted, and the extracted photograph is displayed based on category.

According to another exemplary embodiment of the present disclosure, the step S412 may be follows: when the user requests to display a photograph, according to the stored related information of photographs, if it is determined that at least two albums in the plurality of albums have the photograph, the photograph is only extracted from the album which has the faster access speed, and the extracted photograph is displayed.

According to the current exemplary embodiment of the present disclosure, the related information of photographs may include at least one of the color of a photograph, the name of a photograph, the web attribute of a photograph, place where the photograph was taken, the time when a photograph was taken, a location where a photograph is stored, the time a photograph was stored, and the main object (or subject) of a photograph and the like.

According to an exemplary embodiment of the present disclosure, the management method for managing a plurality of albums may further include: setting and verifying a user name and a password, wherein the user name and the password may be a user name and a password of the management apparatus, and can also be a user name and a password of web albums.

The management apparatus and management method for managing a plurality of albums according to the present disclosure are described with respect to a various operations for photographs, such as copy, move, share, and the like. However, the above description is only explanatory, for example, various operations (such as copy, move, share, and the like) for an album are similar to those for photographs, and the repeated description thereof will be omitted.

Compared with conventional techniques, the present disclosure may achieve at least one of the following technical effects: a management apparatus and management method for managing a plurality of albums (including local albums and web albums) are provided. The plurality of albums can be uniformly managed by using the related information of the photographs in the plurality of albums. The management apparatus and the management method provide a function of sharing photographs or albums, so that sharing of photographs or albums is secure. The present disclosure manages the local albums and the web albums uniformly. The user can view the plurality of albums in category uniformly, so that the user can view the local albums and the web albums uniformly.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A apparatus configured to manage a plurality of albums including photographs, the apparatus comprising:
a storing module configured to store related information of photographs included in the plurality of albums, wherein the related information includes a storage location of each of the photographs;
an extracting module configured to access an album in response to receiving a photograph management request corresponding to at least one photograph, and extract the at least one photograph from the album; and
an updating module configured to update the related information of the at least one photograph stored in the storing module according to the photograph management request.

2. The management apparatus of claim 1, wherein the management request is one of displaying, copying, moving, sharing and deleting a photograph.

3. The management apparatus of claim 2 further comprising:
a displaying module configured to display photographs,
wherein when a request to display a certain photograph is received, the extracting module is further configured to extract the certain photograph from a corresponding album, and send the certain photograph to the displaying module and wherein the displaying module is further configured to display the certain photograph.

4. The management apparatus of claim 3, wherein when a request to display photographs from at least one album in the plurality of albums by category is received, the extracting module is further configured to extract the photographs from the at least one album requested and categorize the extracted photographs based on the related information stored in the storing module and wherein the displaying module is further configured to display the categorized photographs by category.

5. The management apparatus of claim 4, wherein the related information of photographs includes at least one of a color of a photograph, a name of a photograph, a web attribute of a photograph, a location where a photograph was taken, a time when a photograph was taken, the storage location of a photograph, a time when a photograph was stored, and a subject of a photograph.

6. The management apparatus of claim 3, wherein when a request to display a photograph is received and when the extracting module determines that at least two albums in the plurality of albums have the requested photograph according to the related information, the extracting module is further configured to only extract the requested photograph from an album which has the faster access speed among the at least two albums, and send the extracted photograph to the displaying module to be displayed.

7. The management apparatus of claim 3, wherein when a request to display a same photograph located in two or more albums is received, the extracting module is further configured to extract the same photograph from the two or more albums according to the related information and wherein the displaying module is further configured to display the extracted same photograph, and display information on which albums store the same photograph.

8. The management apparatus of claim 3, wherein when a request to copy a photograph from a first album in the plurality of albums to a second album in the plurality of albums is received, the extracting module is further configured to extract the requested photograph from the first album, the storing module is further configured to store the extracted photograph in the second album, and the updating module is further configured to update the related information of the stored photograph.

9. The management apparatus of claim 3, wherein when a request to copy a photograph from a first album in the plurality of albums to a second album in the plurality of albums is received and a photograph cannot be directly copied between the first album and the second album, the extracting module is further configured to extract the requested photograph from the first album, the storing module is further configured to store the extracted photograph to a local memory temporarily, and store the stored photograph in the second album from the local memory, and the updating module is further configured to update the related information of the stored photograph.

10. The management apparatus of claim 3, wherein when a request to move a photograph from a first album in the plurality of albums to a second album in the plurality of albums is received, the extracting module is further configured to extract the requested photograph from the first album and delete the requested photograph from the first album, the storing module is further configured to store the extracted photograph in the second album, and the updating module is further configured to update the related information of the stored photograph.

11. The management apparatus of claim 3, wherein when a request to move a photograph from a first album in the plurality of albums to a second album in the plurality of albums is received, and the requested photograph cannot be directly moved between the first album and the second album, the extracting module is further configured to extract the requested photograph from the first album and delete the requested photograph from the first album, the storing module is further configured to store the extracted photograph to a local memory temporarily, and store the stored photograph in the second album from the local memory, and the updating module is further configured to update the related information of the stored photograph.

12. The management apparatus of claim 3 further comprising:
a sharing module configured to store a photograph extracted by the extracting module, create a link for the stored photograph, send the created link to a website, and, when a time for sharing exceeds a predetermined period, deactivate the link.

13. The management apparatus of claim 1, wherein at least one of the plurality of albums is a web album.

14. The management apparatus of claim 1 further comprising:
a management apparatus module configured to set and verify a user name and a password.

15. A method for managing a plurality of albums including photographs, the method comprising:
receiving a photograph management request corresponding to at least one photograph;
extracting the at least one photograph;
performing the photograph management request corresponding to the at least one photograph; and
updating related information of the at least one photograph among related information of the photographs, wherein the related information of the photographs includes a storage location of each of the photographs.

16. The management method of claim 15, wherein the management request is one of displaying, copying, moving, sharing and deleting a photograph.

17. The management method of claim 16 further comprising:
extracting a certain photograph in response a request for displaying the certain photograph; and
displaying the certain photograph.

18. The management method of claim 16 further comprising:
when a request to display photographs in at least one album in the plurality of albums by category is received, extracting the photographs in the at least one album requested by the user; and
displaying the extracted photographs by category based on the related information.

19. The management method of claim 16, wherein the related information of photographs includes at least one of the color of a photograph, a name of a photograph, a web attribute of a photograph, a location where a photograph was taken, a time when a photograph was taken, the storage location of a photograph, a time when a photograph was stored, and a subject of a photograph.

20. The management method of claim 16, wherein when the user requests to copy a photograph from an album A in the plurality of albums to another album B in the plurality of albums, the photograph is extracted from the album A, the extracted photograph is stored in the album B, and the related information of the photograph is updated.

21. The management method of claim 16 further comprising:
when a request to move a photograph from a first album in the plurality of albums to a second album in the plurality of albums is received, extracting and deleting the requested photograph from the first album, storing the extracted photograph in the second album, and updating the related information of the stored photograph.

22. The management method of claim 16 further comprising:
in response to a request to share at least one of a photograph and an album, accessing an album having stored the photograph or the album requested and extracting the photograph or album requested to be shared;
storing the extracted photograph or album;
creating a link for the stored photograph or album;
sending the created link to a website; and
when one of the photograph or the album is viewed and a time for sharing exceeds a predetermined period, deactivating the link.

23. The management method of claim 15, wherein at least one of the plurality of albums is a web album.
